(19) United States
(12) Patent Application Publication
(10) Pub. No.: US 2003/0033922 A1
(43) Pub. Date: Feb. 20, 2003

(54) Cutter assembly and housing

(76) Inventor: Larry S. Scott, Carrollton, TX (US)

Correspondence Address: SIMPSON & SIMPSON, PLLC, 5555 MAIN STREET, WILLIAMSVILLE, NY, 14221-5406, US

(21) Appl. No.: 09/929,172

(22) Filed: Aug. 14, 2001

(51) Int. Cl. B26D 5/16

(52) U.S. Cl. 83/582; 83/602

(57) ABSTRACT

A cutter assembly, comprising a first cutting member having a first cutting edge, a second cutting member having a second cutting edge, wherein the first and the second cutting edges are disposed in space relative to one another, and a means for biasing the first and second cutting members toward one another to cause a point of cutting contact between the first and the second cutting edges, where the point of cutting contact moves along the first and the second cutting edges over time.

### FIELD OF THE INVENTION

The present invention relates generally to cutters, more specifically to free standing cutters, and even more specifically to cutters used as components of printers, especially those used in kiosk printers, and housings therefor.

### BACKGROUND

Printers, especially kiosk printers used to dispense receipts in automated teller machines, gasoline stations, and cash registers, have undergone substantial improvement over the past several years, resulting in smaller and more efficient machines. Little attention, however, has been paid to the devices that cut the receipts that are dispensed. Historically, the paper on which the receipts are printed was perforated and required the user to manually tear the receipt along a metal or plastic cutting edge. This method was disappointing as the receipt would often tear. Recently, the use of automated paper cutters has appeared, but while advancements in printer technology continues to be made, the cutter devices found in printers, still present problems.

One problem that occurs when cutter devices are used as printer components arises from heat generated by the motors used to power the cutters. Positioning a cutter motor inside a printer inhibits heat dissipation. For example, if the cutter unit is placed too close to the print head, much of the heat generated by the cutter motor is trapped, causing a reduction in print speed and print quality.

Another problem is caused by cutters that cut by pushing a cutting blade in a direction perpendicular to the medium being cut. The serrations required by this system lead to the production of undesirable paper chaff and dust. In addition, the cutting blade tends to chatter from the impact of the blade when cutting the recording paper, making it difficult to cut a straight edge. In addition, serrated cutters pull the recording paper on the upstream side of the cutting position during the cutting operation. This causes uneven paper feeding and printer jams.

Cutters that cut in a desirable scissors-like fashion (i.e., by moving a movable blade across the recording paper to cut from one edge of the paper to the other), also cause uneven paper feed and printer jams because they also pull the recording paper on the upstream side of the cutting position during the cutting operation. Moreover, to avoid the poorly cut edges that result from a change in position of one of the blades, typical scissors type cutters have their fixed and movable blades coupled by a common support pin. While the common support pin maintains the positions of the blades relative to each other, this blade configuration makes it difficult to feed paper between blades.

Automatic rotary type cutters also present problems, these include: high cost, large size requiring extra space, and mechanical complexities that lead to a higher incidence of malfunctions and to distortions in the severed media, i.e., the labels, tickets, receipts, and the like.

A rotary type cutter, of this nature, is disclosed in U.S. Pat. No. 4,572,686 (Tamaka). This cutter is designed to cut labels of various predetermined sizes. The cutting means used by Tamaka comprises a rotating member having a spiral blade and a stationary blade that is biased toward the rotating blade by leaf springs. This cutter relies on a detecting means programmed to sense “cutting” marks that are placed on the paper to determine where the paper should be cut. This system can take advantage of the fold lines on Z folded paper to define cutting positions. However, if the fold is not positioned exactly, the paper may be caught between the cutter blades without being cut. While the physical mechanics of this cutting system are relatively simple, the Tamaka cutting device cannot work without its “electronic eye”, which determines when the cutting mechanism should be activated. In addition, the Tamaka cutter requires leaf springs whose resilience decreases with time. This decrease reduces the cutter's cutting ability and causes frequent paper jamming.

A specialized-use rotary cutter is presented in U.S. Pat. No. 6,129,8810 (Schweltzer). This cutter, used to cut adhesive backed labels, includes a stationary anvil blade and an automatic rotary cutter. The rotary cutter includes a rotary blade that is mounted on a rotating shaft and is powered by an electrical motor under computer control. The cutter system includes a wiper to wipe the blade free from the adhesive and was designed for use in label dispensers that dispense labels having pressure sensitive adhesive face.

U.S. Pat. No. 4,165,191 (Dickson et al.) discloses a shearing cutter assembly comprising a movable guillotine blade that cooperates with a stationary blade. This cutter assembly, however, requires a complex system of guides, a spring, shaft, stub shaft, cam, lever, and disc. This bulky system, with its multiple components, requires a large amount of space. This, of course, means that this system can only be used in large sized printers.

Thus, there is still a need for a cutter that is economical, safe and compact, such that it can be used in various models and sizes of printers, or as a stand-alone cutting device. Moreover there is a need for a printer that requires a motor of modest size that is positioned to allow generated heat to be efficiently and quickly dissipated. Finally, there is a need for a cutter that provides a clean, even cut using a scissors-type cutting action without having its cutting blades joined by a common rotatable support pin.

### SUMMARY OF THE INVENTION

The present invention comprises a cutter assembly having a first cutting member having a first cutting edge, a second cutting member having a second cutting edge, wherein the first and the second cutting edges are disposed in space relative to one another, and a means for biasing the first and second cutting members toward one another to cause a point of cutting contact between the first and the second cutting edges, where the point of cutting contact moves along the first and the second cutting edges over time.

In a preferred embodiment of the present invention there is a cutter assembly comprising a first cutting member having a first cutting edge and a second cutting member having a second cutting edge where the first cutting member is an upper cutting blade and the second cutting member is a lower cutting blade, although it should be readily apparent to those skilled in the art that the converse would work equally as well.

In accordance with the present invention, there is provided a cutter assembly that cuts in a scissors-like fashion to produce even, clean cuts without the production of any chaff or dust. Although the cutter assembly of the present invention cuts using a scissors-like action, its cutting blades are not coupled. This eliminates the paper feed problems found in cutters having cutting blades that are connected to each other. Additionally, the receiving and exiting guides, that are a part of this invention, pilot the material to be cut through the cutter assembly, avoiding uneven feeds of the material to be cut.

The cutter assembly of the present invention works without the complex and cumbersome sets of pulleys and belts that are required by rotary cutters, thus reducing the frequent and costly repairs that are common in such systems and allowing for a smaller and more compact cutter assembly. The simple design of the cutter assembly of the present invention means that the cutter works more efficiently than the more complex cutter devices. Greater efficiency translates to a need for less operating power, thus, minimizing the amount of heat produced. This, coupled with the fact that the motor of the cutter assembly of the present invention is placed in a vented area of the cutter housing, avoids the heat buildup that impedes machine functions. A reduction in heat build-up is especially important when cutters are components of kiosk printers because of the severe limited space in which kiosk printers are placed.

The uncluttered, straight-edged design of the housing of the cutter assembly of the present invention permits the cutter to be used safely as either a self-standing cutting device or as a component of a printer device. The housing ensures that the cutting blades are safely out of reach when the cutter is used as a free-standing device, as well as when the cutter is used as a component in a printer, specifically when the interior of the printer must be accessed, to disengage a paper jam, for example. The design of the cutter assembly of the present invention allows it to cut material that is Z-folded, stacked, or off of a roll, regardless of the size of the roll.

It is a general object of the present invention to provide a cutter assembly having a simple cutting mechanism that provides a clean, even scissors-like cut.

It is another object of the present invention to provide a cutter assembly that requires little space.

It is a further object of the present invention to provide a cutter assembly having cutting blades safely positioned within a housing.

It is still another object of the present invention to provide a cutter assembly housed in a housing of simple design to allow such cutter assembly to be used as a self-standing cutting machine to cut a desired material, such as cloth or paper.

It is still a further object of the present invention is to provide for a cutter assembly for use as an integral part of a printer of the kind that dispenses receipts and the like.

All of the above objects are accomplished by a cutter assembly comprising

a) a first cutting member having a first cutting edge;

b) a second cutting member having a second cutting edge, where the first and second cutting edges are disposed at an acute angle relative to one another; and

c) means for biasing the first and second cutting members toward one another to cause a point of contact between the first and second cutting edges, where the point of contact moves along the first and the second cutting edges over time.

It is preferred that the cutter assembly have a housing that completely and safely encases the cutter assembly, and in addition, provides a structural frame to which the cutter assembly is attached.

These and other objects, features, and advantages of the present invention will become apparent upon a reading of the detailed description and claims in view of the several drawing figures.

### BRIEF DESCRIPTION OF THE DRAWINGS

FIG. 1 is a perspective view of the cutter assembly of the invention;

FIG. 2 is a perspective view of the cutter assembly of the invention showing paper entering and leaving the cutter;

FIG. 3 is an exploded view of the cutter assembly of the invention;

FIG. 4 is a cross-sectional view of the cutter assembly, taken generally along line 4-4 of FIG. 9, illustrating the cutter blades in a ready-to-cut position;

FIG. 5 is a cross-sectional view of the cutter assembly, taken generally along line 5-5 of FIG. 10, illustrating the cutter blades after a 90° crank rotation;

FIG. 6 is a cross-sectional view of the cutter assembly, taken generally along line 6-6 of FIG. 11, illustrating the cutter blades after a 180° crank rotation;

FIG. 7 is a cross-sectional view of the cutter assembly, taken generally along line 7-7 of FIG. 12, illustrating the cutter blades after a 270° crank rotation;

FIG. 8 is a cross-sectional view of the cutter assembly taken generally along line 8-8 of FIG. 13, illustrating the cutter blades in resolution, i.e., after a 360° crank rotation;

FIG. 9 is an end view of the cutter assembly, taken generally along line 9-9 of FIG. 4, illustrating the cutting blades in a ready-to-cut position;

FIG. 10 is an end view of the cutter assembly, taken generally along line 10-10 of FIG. 5, illustrating the cutting blades after a 90° crank rotation;

FIG. 11 is an end view of the cutter assembly, taken generally along line 11-11 of FIG. 6, illustrating the cutting blades after a 180° crank rotation;

FIG. 12 is an end view of the cutter assembly, taken generally along line 12-12 of FIG. 7, illustrating the cutting blades after a 270° crank rotation;

FIG. 13 is an end view of the cutter assembly, taken generally along line 13-13 of FIG. 8, illustrating the cutting blades in resolution, i.e., after a 360° crank rotation;

FIG. 14 is a fragmentary end view of the cutter assembly (with part of the cutter assembly housing removed) to illustrate the torsion spring when the cutting blades are in ready-to-cut position; this end view is taken generally along line 14-14 of FIG. 4;

FIG. 15 is an orthographic view illustrating how first cutting edge 20 of first (upper) cutting blade 22 is positioned in space relative to second cutting edge 30 of second (lower) cutting blade 24;

FIG. 16 is an orthographic view of first cutting edge 20 of first (upper) cutting blade 22 and second cutting edge 30 of second (lower) cutting blade 24 illustrating point-of-contact 50, shortly after the cutter blades begin cutting;

FIG. 17 is an orthographic view of first cutting edge 20 of first (upper) cutting blade 22 and second cutting edge 30 of second (lower) cutting blade 24 illustrating point-of-contact 50 after the cutting blades are about halfway through a cut;

FIG. 18 is an orthographic view of first cutting edge 20 of first (upper) cutter blade 22 and second cutting edge 30 of second (lower) cutting blade 24 and point of cutting contact 50 where the cutter blades are close to completing a cut;

FIG. 19 is an enlarged fragmentary perspective view of the encircled area in FIG. 4, showing the spatial relationship of first (upper) cutting blade 22 and second (lower) cutting blade 24 just prior to cutting; and,

FIG. 20 is an enlarged fragmentary perspective view of first (upper) cutter blade 22 and second cutter blade 24, illustrating that the two blades, as viewed from the top, are disposed at an angle θ with respect to one another, and also showing point of cutting contact 50 between the two blades; this view is taken from the encircled area, so indicated, in FIG. 5.

### DETAILED DESCRIPTION OF THE PREFERRED EMBODIMENT

At the outset, it should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification, and are to be construed as a portion of the entire “written description” of this invention, as required by 35 U.S.C. §112. As used in the following description, the terms “right,” “left,” “up,” “down,” “clockwise,” and “counterclockwise” refer to the orientation of the illustrated structure as the particular drawing figures face the reader, except as otherwise noted.

The present invention comprises a cutter assembly for use in cutting a material, such as paper, plastic, or cloth, is to be cut. The compact design of the cutter and its housing makes it especially ideal for use as a free-standing cutter or as a component of printers, especially kiosk printers. The cutter assembly comprises a first cutting member having a first cutting edge and a second cutting member having a second cutting edge, where the first and second cutting edges are disposed at an acute angle relative to one another. The two blades are arranged in space at a non-parallel angle with respect to one another in a first plane, and at a non-parallel angle with respect to one another in a second plane, such that the respective blade cutting edges contact one another at but a single point. Means for biasing the first and second cutting members toward each other serve to cause the first cutting edge of the first cutting member to meet the second cutting edge of the second cutting member at a point of contact, where the point of contact moves along the first and second cutting edges over time (from left to right in a preferred embodiment) to provide for a smooth scissors-like cut. It should be appreciated that, although the point of contact, and therefore the cutting action, moves from left to right from the perspective of one facing the drawings in a preferred embodiment, the drive mechanism and geometry/structure of the present invention could easily be reversed, as will be appreciated by those having ordinary skill in the art, such that the cutting action would proceed from right to left.

For purposes of this patent, the terms appearing below in the description and the claims are intended to have the following meanings:

The terms “cutting blade” and “cutting member” are used synonymously and interchangeably herein.

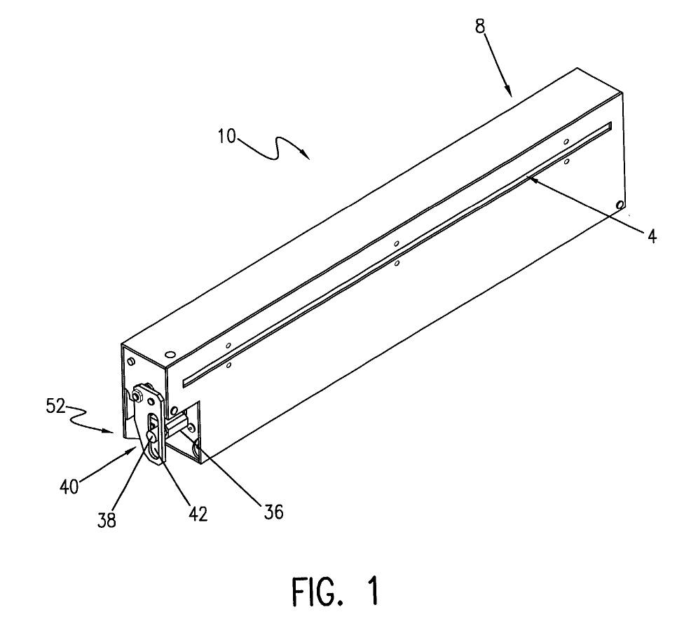

Adverting now to the drawings, cutter assembly 10 is shown in FIGS. 1, 2, and 3. The cutter assembly is operatively arranged to cut paper, or other similar material. In a preferred embodiment, the cutter assembly is intended for use in a kiosk printer, such as that found in cash registers, ATM machines, or the like. It should be appreciated, however, that the cutter assembly of the present invention is suitable for use in other types of printers, and in other types of machines generally. The neat, simple, compact design of cutter assembly 10 makes it especially attractive for use in kiosk printers as kiosk printers are typically designed for use in places where space is severely limited.

### Structure

FIG. 1 is a perspective view of cutter assembly 10. Cutter assembly 10 is shown to comprise housing 8, generally rectangular in shape, although it will become readily apparent that other shapes are suitable for its construction as well. Cutter assembly 10 is seen to include exit port 4, operatively arranged to eject paper after cutting. Also shown in FIG. 1 is cam follower assembly 52, operatively arranged to move a lower cutting blade, as will be described in more detail infra.

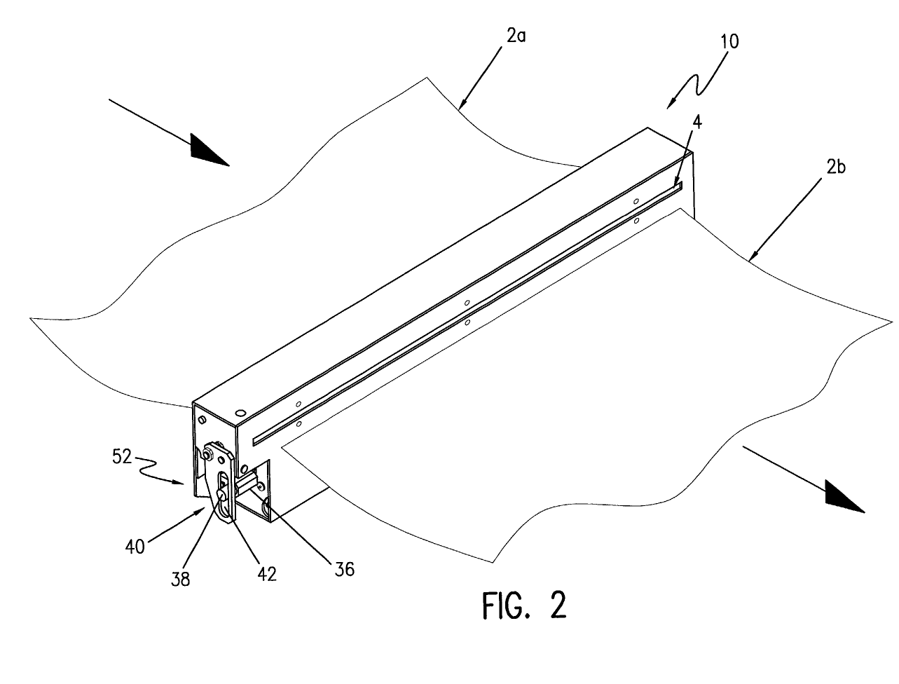

FIG. 2 is a perspective view of the cutter assembly as shown in FIG. 1, but shown in the process of cutting paper. Paper sheet 2b, having just been cut from paper sheet 2a by cutter device 10, is shown exiting cutter device 10 through exit port 4.

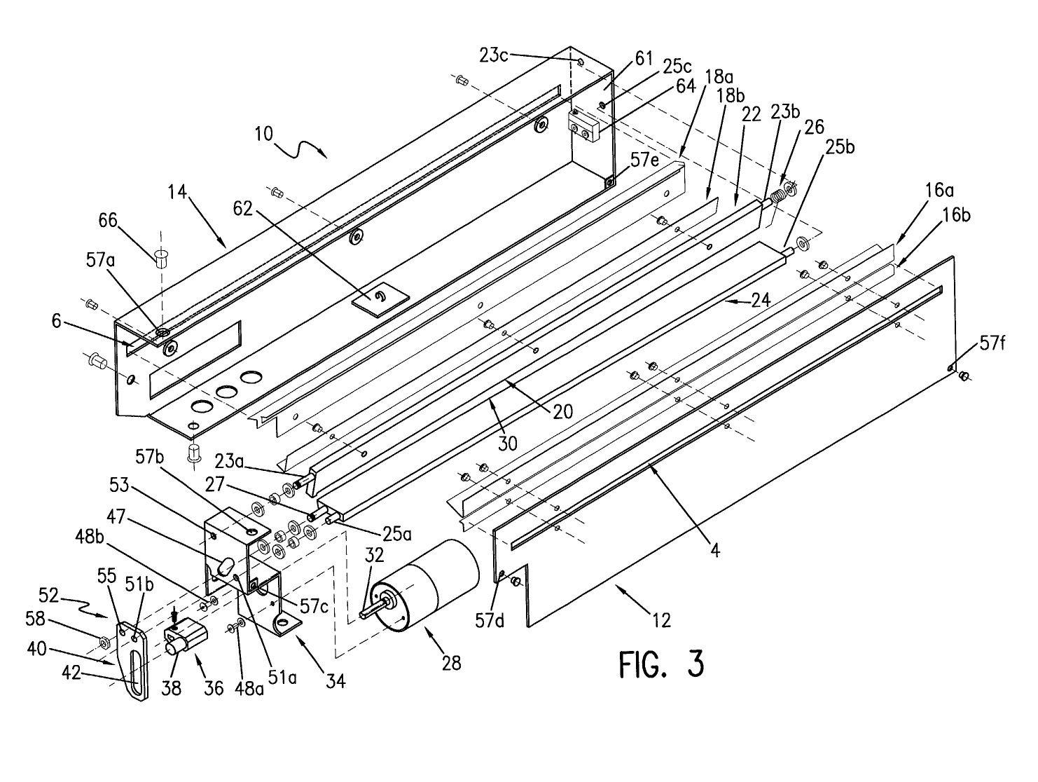

FIG. 3 is an exploded view of cutter assembly 10. Housing 8 (also shown in FIG. 1) serves as both a casing and a support for the components of cutter assembly 10. For the purpose of illustration, housing 8 is shown in three sections, housing front plate 14, housing back cover plate 12, and housing plate bracket and motor support 34.

Housing front section 14 includes inlet port 6 arranged to receive material to be cut. Once the material to be cut enters cutter assembly 10, it is guided through the cutter assembly by receiving and exiting guide assemblies that comprise the following components. Lower part 18a of the receiving guide assembly is fixedly attached to housing front cover plate 14. Upper part 18b of receiving guide assembly is fixedly attached to upper cutter blade 22.

Exit port 4 is operatively positioned in housing back cover plate 12 to allow the cut material to exit cutter assembly 10. An exit guide assembly is comprised of upper part 16a and lower part 16b, both of which are fixedly attached to housing back cover plate. Housing back cover plate 12 is fixedly attached to side plate 61 of housing front plate 14 through apertures 57e and 57f and to housing plate bracket and motor support 34 through apertures 57c and 57d.

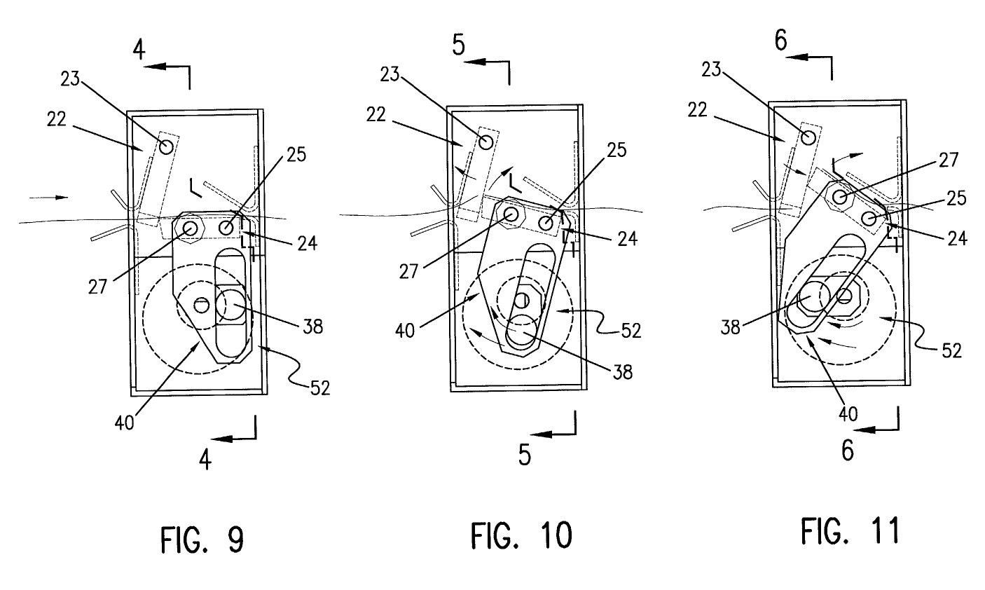

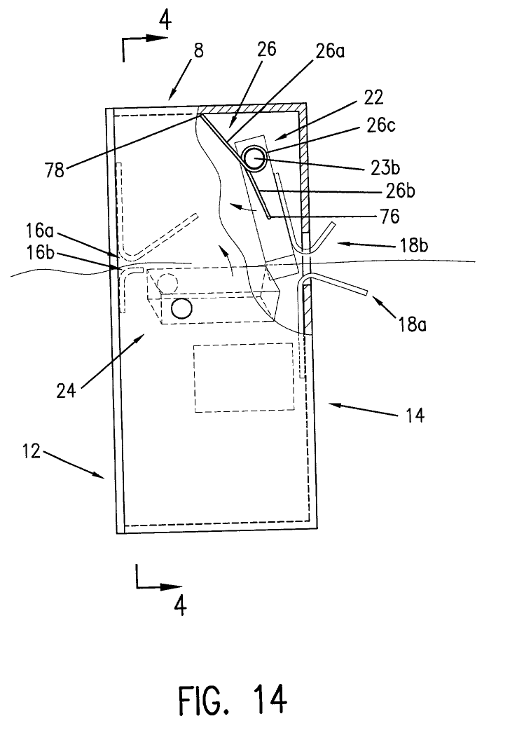

The cutting action of cutter assembly 10 depends on the cooperative interaction of upper cutting blade 22 and lower cutting blade 24, and on the positioning of the two blades relative to one another in space. Pivot pin 23a extends outwardly from the left end of first (upper) cutting blade 22 and is operatively arranged for pivoting in aperture 53 in housing plate bracket 34. Pivot pin 23b extends outwardly from the right end of first (upper) cutting blade 22 and is operatively arranged for pivoting in aperture 23c of side plate 61. Pivot pins 23a and 23b of first (upper) cutting blade 22 define an axis of rotation 23 for the second (lower) cutting blade (as indicated in FIGS. 9-13). Pivot pin 23b also serves to hold torsion spring 26, which biases first (upper) cutting blade 22 toward second (lower) cutting blade 24 (as best shown in FIG. 14). In other words, the coil of the torsion spring is wrapped around the pivot pin.

Pivot pin 25a extends outwardly from the left end of lower cutting blade 24 and is operatively arranged for pivoting in aperture 51a of plate bracket 34 and aperture 51b of follower 40. In addition, pin 27 extends outwardly from the left end of second (lower) cutting blade 24. Pin 27 passes through slot 47 in plate bracket 34 and passes through aperture 55 of follower 40. Pin 27 is fixedly secured to follower 40 by nut 58. Housing plate bracket 34 is attached to front section of housing 8 by flathead locktite 66 through apertures 57a in front housing plate 14 and 57b in housing plate bracket 34.

Pivot pin 25b extends outwardly from the right end of lower cutting blade 24 and is operatively arranged for pivoting in aperture 25c of side plate 61 of front housing plate 14. Pivot pins 25a and 25b of second (lower) cutting blade 24 define an axis of rotation 25 for the second (lower) cutting blade (as indicated in FIGS. 9-13).

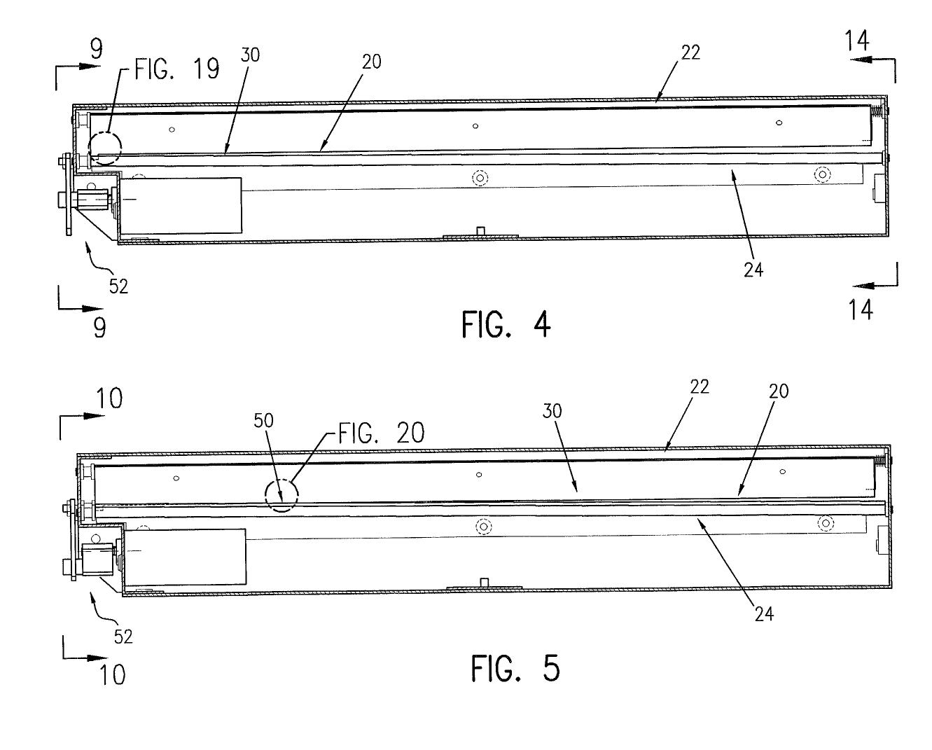

Averting now to FIG. 14, spring leg 26a of torsion spring 26 is shown buttressed by housing 8 at point 78. Torsion spring coil 26c is shown coiled around pivot pin 23b that extends outwardly from the right end of first (upper) cutting blade 22. Torsion spring leg 26b is fixedly attached to first (upper) cutting blade 22 by insertion of the end of 26b into aperture 76 (the insertion of the end of spring leg 26b into aperture 76 is also illustrated in FIG. 4 within the dashed circle around the arrowhead of reference number 50). Torsion spring 26 biases first (upper) cutting blade 22 in the direction of second (lower) cutting blade 24 as indicated. The direction in which second (lower) cutting blade 24 is biased toward first (upper) blade 22, around axis of rotation 25, is also indicated.

FIG. 14 also illustrates the fixed attachment of upper part 18b of the receiving guide assembly to first (upper) cutter blade 22 and of lower part 18a of the receiving guide assembly to front housing plate 14, and the fixed attachment of both upper and lower parts, 16a and 16b, of the exit guide assembly to housing back cover plate 12

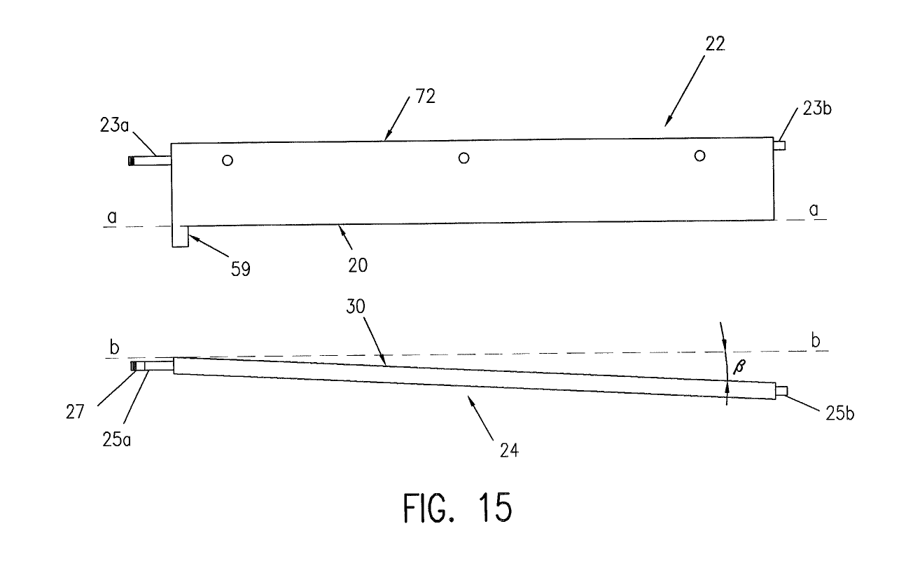

FIG. 15 best illustrates the first cutting edge 20 of first (upper) cutting blade 22. First (upper) cutting blade 22 is shown spaced apart from second (lower) cutting blade 24 to better illustrate cutting edge 20. As shown in the drawing, top edge 72 of first (upper) cutting blade 22 is parallel to horizontal line “a-a”. Line “b-b”, shown in the drawing as parallel to line a-a, is also tangent to second cutting edge 30 of second (lower) cutting blade 24 (that is, the line intersects the cutting edge at only one point). It is important to note, then, that second cutting edge 30 of second (lower) cutting blade 24 is arranged at an acute angle β relative to line b-b (and therefore also relative to line a-a). That is, the second cutting edge is arranged at a downwardly sloping angle from left to right as one faces the drawings, with respect to the first cutting edge. As shown in FIG. 20, from a top perspective (that is, looking down on the blades shown in FIG. 15) the right end of blade 24 is closer to blade 22 than the left end of blade 24. Thus, blade 24 is positioned at an angle with respect to blade 22 in two planes, such that the two blades intersect one another at but a single point.

FIG. 15 also illustrates projection 59 extending downwardly from the left end of edge 20 of first (upper) cutting blade 22. The projection functions to keep the torsion spring from pivoting the upper blade over the lower rotating blade during cutting when the rotation blade reaches its “home” position.

Adverting again to FIG. 3, split locks 48a and 48b fixedly attach rotary motor 28 to housing plate bracket 34 thereby supplying the support for rotary motor 28. Rotary motor 28 is attached to crank 36 by motor shaft 32. Crankshaft 38 extends from crank 36 and protrudes through opening 42 in follower 40 so that crankshaft 38 engages follower 40. Positioning the motor at the end of cutter housing 8 allows any heat produced by the motor to rapidly dissipate. Motor 28 is activated via micro-switch 64 through a power cable (not shown). The cable is held in place within the housing by cable tie anchor 62.

### Cutting Operation

Operation of the invention is best understood by referencing the cross sectional views of FIGS. 4 through 8, which should be viewed in conjunction with their respective end views, shown in FIGS. 9 through 13. The cutting contact of the upper and lower cutting blades is best understood with reference to FIGS. 15-20. FIGS. 4 through 8 illustrate the relationship of cutting edges 20 and 30 as they progress through a cutting cycle. FIGS. 9 through 13 illustrate how rotary motor 28 biases lower cutting blade 24 toward upper cutting blade 22. As the reader progresses from FIGS. 9 through 13, it should be understood that the clockwise rotation of motor 28 drives crank 36 and crankshaft 38 to rotate in a clockwise direction which, in turn, provides the force to move follower 40. This, in turn, causes lower cutting blade 24 to rotate into cutting contact with upper cutting blade 22. The upper and lower blades contact one another at a point-of-contact 50, which moves quickly from left to right from the perspective of one viewing the drawings. As the point-of-contact moves rightwardly, the paper is sheared. FIGS. 15 through 20 are enlarged views to better illustrate the relationship of the upper cutting blade with the lower cutting blade at the cutting point of contact.

As best shown in FIG. 14, upper blade 22 is biased toward lower blade 24 by the action of torsion spring 26, and lower blade 24 is biased toward upper blade 22 by rotary motor 28 (best seen in FIG. 3). A clean, even, scissors-like cutting action results from the biasing of upper blade 22 and lower blade 24 toward one another, and from the angular displacement and position in space of each relative to the other.

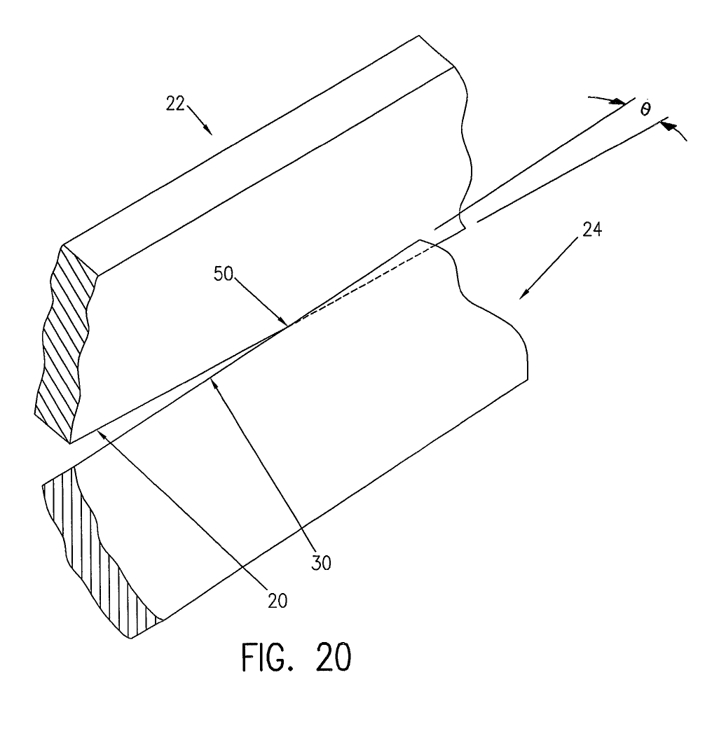

Adverting now to FIGS. 4 and 9, these drawings show the apparatus just prior to cutting. In these drawings, upper cutting blade 22 and lower cutting blade 24 are positioned relative to one another at an angle slightly less than 90° from the end-view perspective of FIG. 9. To begin the cutting sequence, lower blade 24 is rotated upwardly in a clockwise direction by motor-driven cam follower 40 toward upper blade 22, which, in turn, is biased toward lower cutting blade 24 by torsion spring 26 (best shown in FIG. 14). Lower blade 24 first comes into cutting contact 50 with upper blade 22 at the extreme right end of both blades as shown in FIG. 4. The point of cutting contact 50 is also shown as part of an enlarged fragmentary perspective view in FIG. 19 taken from the encircled area shown in FIG. 4.

Actual cutting begins as a 90° clockwise rotation of crankshaft 38 moves follower 40 and cutting blade 24 from a ready-to-cut position as shown in FIGS. 4 and 9, to a cutting position as shown in FIGS. 5 and 10. As illustrated in FIG. 10, cutting blade 24 has rotated toward cutting blade 22, about axis of rotation 25, by the motion of follower 40. Follower 40 is able to move cutting blade 24 by virtue of cutting blade 24 being connected to follower 40 by shaft 27.

FIG. 5 shows how point of cutting contact 50 of cutting edges 20 and 30 has moved leftwardly as follower 40 has rotated 90° (as illustrated in FIG. 10) relative to its original position. FIG. 20 is an enlarged fragmentary perspective view of point of cutting contact 50 taken from the circled area as indicated in FIG. 5.

The movement of the point of contact of the cutting edges, from right to left as depicted in FIGS. 4 through 6, provides for a clean-edged scissors-like cut even though the cutting blades are not attached at a common pivot point and are moving in a shearing motion relative to one another. It should be appreciated that the upper blade is pivoting about an axis while biased by the torsion spring, while the lower blade is rotating simultaneously. These mutual movements, in combination with the relative positions of the two blades relative one another in space, causes a cutting of the paper (or other material) smoothly, cleanly, quickly, and efficiently, from left to right.

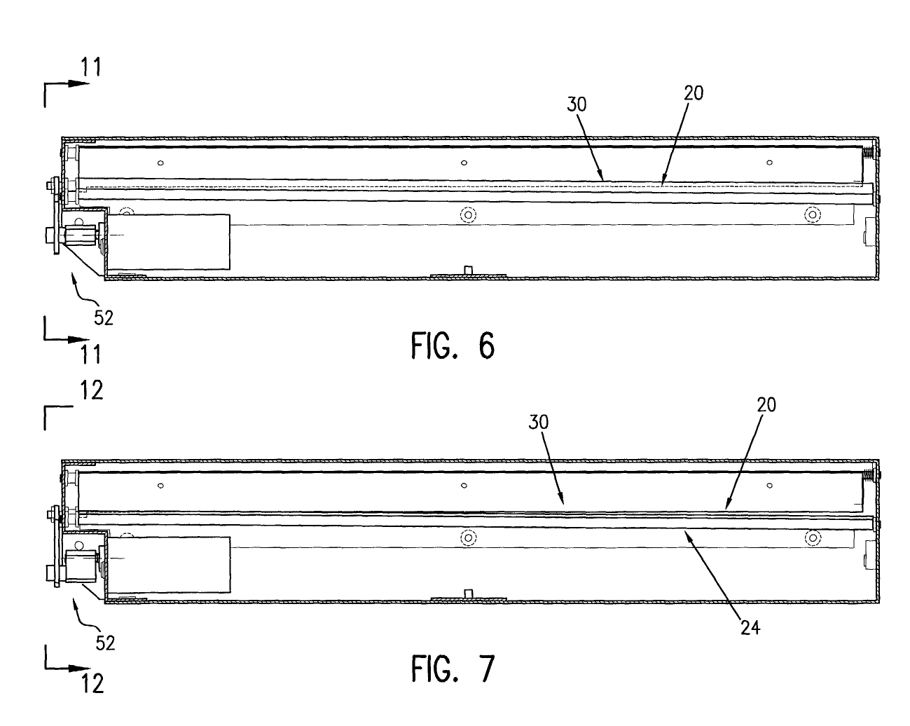

FIGS. 6 and 11 illustrate the relative positions of cutting edges 20 and 30 after follower 40 has rotated 180° about rotation axis 25 relative to its original position. At this point, cutting blade 24 begins its return to its starting position, as shown in FIG. 9. Also at this point, the leading edge of cutting edge 30 is no longer in contact with upper cutting edge 20. This explains why no point of cutting contact 50 is shown in FIGS. 6-8.

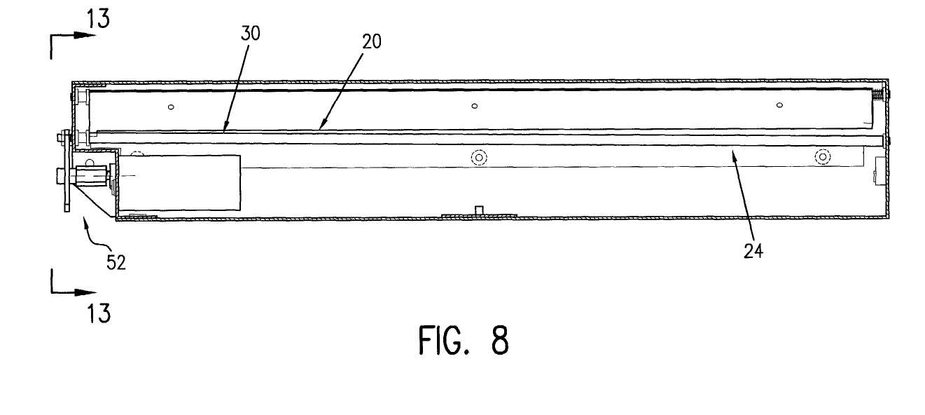

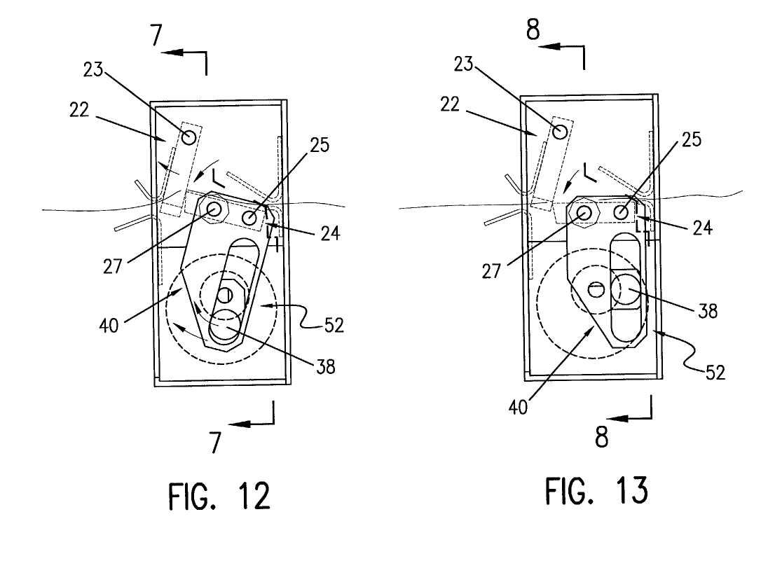

FIGS. 7 and 12 show the relative positions of cutting edges 20 and 30 and the position of follower 40, after crankshaft 38 has completed 270° of rotation relative to its original position. FIG. 8 shows cutting edges 20 and 30 and FIG. 13 shows follower 40 in resolution after crankshaft 38 completes a full 360° of rotation. FIG. 14 illustrates the biasing of cutting blade 22 toward cutting blade 24 by torsion spring 26, as discussed infra.

FIGS. 3 and 14 best illustrate that material to be cut enters cutter assembly 10 through receiving port 6 guided by the upper 18b and lower 18a parts of the receiving guide assembly. Once cut, the medium is guided by upper part 16a and lower part 16b of the exiting guide assembly through exiting port 4 in housing back cover plate 12 to exit cutter assembly 10.

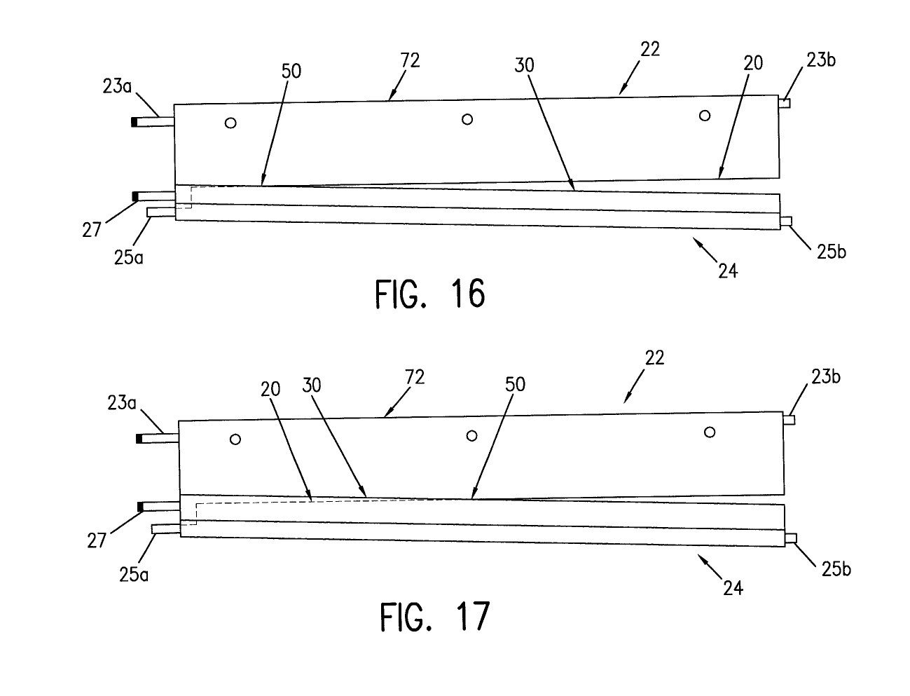

FIGS. 16-18 are orthographic views that also illustrate the relative positions of the upper and lower cutting blades and movement of the point of contact between the blades during cutting. FIG. 16 is an orthographic view of cutting edge 20 and cutting edge 30 shown at a point in time shortly into the cutting process (with the blades now positioned for cutting as compared to their spaced position in FIG. 15). This view shows that the point of cutting contact 50 has moved slightly to the right from its extreme left starting position as shown in FIG. 4.

FIG. 17 is another enlarged orthographic view of first cutting edge 20 and second cutting edge 30, showing the position of point of cutting contact 50 when the blades are about halfway through a cut.

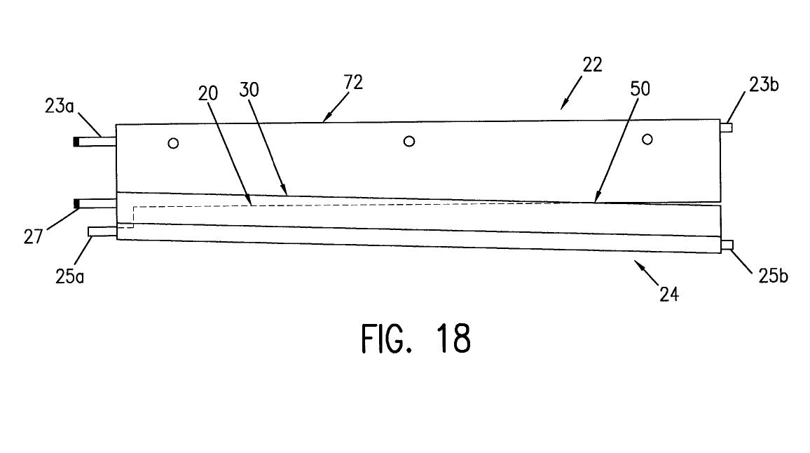

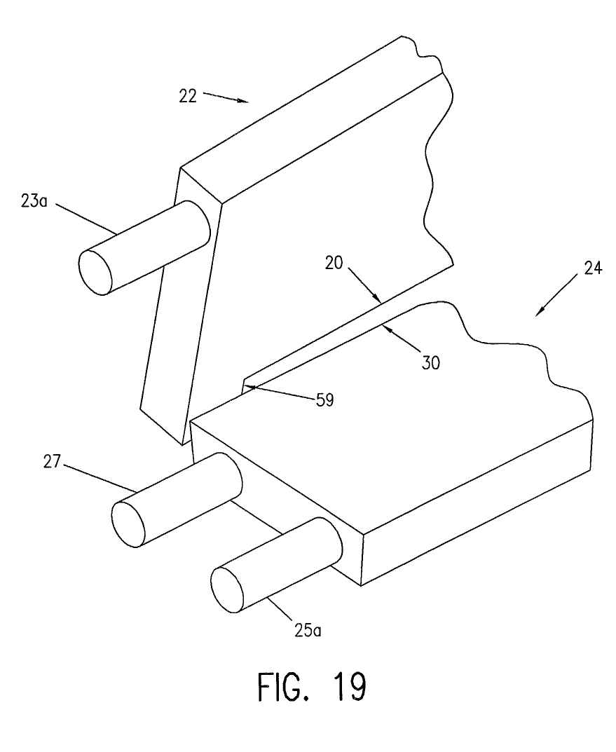

FIG. 18 is yet a further enlarged orthographic view of first cutting edge 20 and second cutting edge 30, showing point of cutting contact 50 at the far right as one cutting cycle is close to completion.

Rotary motor 28 can be powered by any conventional means known in the art. Rotary motor 28 is activated by micro-switch 64 (shown in FIG. 3) which is connected to the motor by a cable (not shown) that is held is place by cable tie anchor 62. In operation, the micro-switch is mechanically actuated by the rotating blade. It is operated, as the blade leaves and returns to its “home” position. It only indicates the “home” or “not at home” position of the rotating blade. The power to the motor is turned on and off by a controller. The controller monitors the micro-switch for the rotating blade to return “home”. The controller turns off power to the motor when the micro-switch indicates that the rotating blade has returned to its “home position. It should be apparent to those having ordinary skill in the art that the speed of the paper feed and speed of rotation of the motor should be selected to cut desired lengths of paper. Obviously, variations in these respective speeds will result in different lengths of cut paper.

FIG. 16 is an enlarged orthographic view of first cutting edge 20 and second cutting edge 30 shown at a point in time shortly into the cutting process (with the blades now positioned for cutting as compared to their spaced position in FIG. 15). This view shows that the point of cutting contact 50 has moved slightly to the right from its extreme left starting position as shown in FIG. 4.

FIG. 17 is another enlarged orthographic view of first cutting edge 20 and second cutting edge 30, showing the position of point of cutting contact 50 when the blades are about halfway through a cut.

FIG. 18 is yet a further enlarged orthographic view of first cutting edge 20 and second cutting edge 30, showing point of cutting contact 50 at the far right as one cutting cycle is close to completion.

Although there are a range of suitable dimensions and angles for the blades and other structural components of the cutter assembly, in a preferred embodiment, the right end of the rotating blade is approximately 0.16″ lower and 0.14″ closer to the stationary blade than the left end. The entire rotating blade is positioned toward the stationary blade to pivot the stationary blade clockwise to an angle of approximately 20 degrees from the vertical. This is so the thickness of the stationary blade contributes to the funnel of the guides and the paper path. The entire rotating blade is positioned so that the left end of its cutting edge is approximately 0.06″ below the left end of the cutting edge of the stationary blade. This is to leave an opening for the leading edge of the paper to enter. This opening is greater at the right end of the cutter, due to the right end of the rotating blade being lower than the left end. The rotating blade is positioned at an angle of approximately 5 degrees clockwise from its pivot point. This is to prevent the cutting edge from dragging the leading edge of the next piece of paper down, while it is returning to “home”. The included angle between the rotating blade and the stationary blade is approximately 75 degrees. The rotating blade pivots clockwise through an angle of approximately 45 degrees. This is all that is required to complete a cut within the manufacturing tolerances of the assembly. The upper “stationary” blade is not truly stationary. It pivots slightly during a cut. This makes a cut across the paper, at an angle of approximately ¼ degree. This could have been compensated for in the housing, but it would be probably lost in the manufacturing tolerances.

Thus, it is seen that the objects of the invention are efficiently obtained. It should be appreciated, however, that the invention is not directed solely to the particular embodiment described herein, but is capable of various modifications, rearrangements, and substitutions should be readily apparent to those having ordinary skill in the art without departing from the scope of the invention as claimed.

For example, it should be readily apparent to those having ordinary skill in the art that although in the embodiment disclosed herein a rotary drive is used to bias one cutting member (cutting blade 24 as described herein) toward a second cutting member (cutting blade 22 as described herein), other means can be readily used, such as the use of a hydraulic cylinder to push one cutting member toward a second cutting member, the use of a compression spring operatively arranged to exert pressure on one cutting member to bias it toward a second cutting member, or even the use of a solenoid to exert the necessary pressure. Additional biasing means includes the use of an electromagnet and the use of a magnetic material to manufacture one, or both, of the cutting members.

Thus, it is seen that the scissors cutting action is created by the rotating cutter blade (lower blade) being placed at an angle across the cutter frame in relationship to the “stationary” upper cutter blade. The right (non-driven) end of the rotating blade is positioned lower than the left (driven) end. The right end of the rotating blade is also positioned closer to the stationary blade. This “lower and closer” relationship can be at any suitable angle that will keep the cutting edge of the rotating blade in contact with the cutting edge of the stationary blade, while it is rotating through the required angle. It should be appreciated, also, that there is, in a preferred embodiment, a small relief angle across the thickness of the rotating blade to prevent that surface from touching the stationary blade cutting edge during the cut cycle.

It should be appreciated that the entire structural relationship of the cutter assembly could be mirrored, such that cutting would occur from right to left, instead of from left to right. It should also be appreciated that the cutter works with the motor and crank running in either direction. In the preferred embodiment, the crank is powered in the clockwise direction and does the cutting while the crank pin is farthest from the rotating blade pivot point, (in the farthest end of the crank follower slot). This supplies a higher leverage/torque to the blade while it is cutting. The return to “home” is done during the part of the rotation when the crank pin is closest to the rotating blade pivot point, (in the closest end of the crank follower slot), when less power is required to return the rotating blade to “home” and complete the cut cycle.

What is claimed is:

1. A cutter assembly, comprising:
a) a first cutting member having a first cutting edge;
b) a second cutting member having a second cutting edge, wherein said first and said second cutting edges are disposed in space relative to one another; and
c) a means for biasing said first and second cutting members toward one another to cause a point of cutting contact between said first and said second cutting edges, where said point of cutting contact moves along said first and said second cutting edges over time.

2. The cutter assembly of claim 1, wherein said means for biasing said first and second cutting members toward one another to cause a point of cutting contact comprises:
a) a first means for biasing said first cutting member; and
b) a second means for biasing said second cutting member.

3. The cutter assembly of claim 2, wherein said first means for biasing said first cutting member toward said second cutting member comprises a torsional spring.

4. The cutter assembly of claim 3, wherein said second means for biasing said second cutting member toward said first cutting member comprises a motor driven cam follower.

5. The cutter assembly of claim 1 wherein said cutter assembly comprises a housing having an inlet port operatively arranged to receive material to be cut by said cutter assembly.

6. The cutter assembly of claim 1 wherein said cutter assembly comprises a housing having an exit port operatively arranged to dispense cut material from said cutter assembly.

7. The cutter assembly of claim 1 wherein said first cutting member further includes a first end including a first pivot pin and a second end including a second pivot pin, wherein said first and second pivot pins are coaxially aligned, and said first cutting member is operatively arranged for biased rotation about said coaxially aligned first and second pivot pins.

8. The cutter assembly of claim 1 wherein said second cutting member further includes a first end including a first pivot pin and a second end including a second pivot pin, wherein said first and second pivot pins are coaxially aligned, and said second cutting member is operatively arranged for biased rotation about said coaxially aligned first and second pivot pins.

9. The cutter assembly of claim 7 further comprising a torsion spring operatively arranged to cause said biased rotation of said first cutting member.

10. The cutter assembly of claim 8 further comprising a motor driven cam follower operatively arranged to cause said biased rotation of said second cutting member.
